(19) United States
(12) Patent Application Publication
(10) Pub. No.: US 2025/0081096 A1
(43) Pub. Date: Mar. 6, 2025

(54) METHOD, APPARATUS AND COMPUTER PROGRAM

(71) Applicant: Nokia Technologies Oy, Espoo (FI)

(72) Inventors: Oana-Elena BARBU, Aalborg (DK); Nuno Manuel KIILERICH PRATAS, Aalborg (DK); Benny VEJLGAARD, Gistrup (DK); Johannes HARREBEK, Aalborg (DK); Simon SVENDSEN, Aalborg (DK)

(21) Appl. No.: 18/819,454

(22) Filed: Aug. 29, 2024

(30) Foreign Application Priority Data
Sep. 1, 2023 (GB) 2313372.1

(51) Int. Cl. H04W 48/20; H04W 28/18; H04W 72/0453

(52) U.S. Cl. CPC H04W 48/20; H04W 28/18; H04W 72/0453

(57) ABSTRACT

An apparatus including means for receiving an activation signal; means for transmitting a reply to the activation signal over a carrier; means for selecting the carrier based on a delay used by the apparatus between the receipt of the activation signal and the transmission of the reply.

### FIELD

The present application relates to an apparatus, method and computer program. In particular, but not exclusively, the present application relates to Internet of Thing (IoT) devices. Some examples relate to Ambient IoT (A-IoT) devices.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect there is provided an apparatus comprising: means for receiving an activation signal; means for transmitting a reply to the activation signal over a carrier; means for selecting the carrier based on a delay used by the apparatus between the receipt of the activation signal and the transmission of the reply.

According to some examples, the carrier is selected based on a mapping between a delay value range or a delay value and the carrier.

According to some examples, the mapping is either a predetermined mapping or is received from a network entity configured to manage a positioning session for the apparatus.

According to some examples, the apparatus comprises: means for receiving, from the network entity, at least one of: information indicative of an identifier of a network entity configured to activate the apparatus; information indicative of an identifier of a network entity configured to detect the apparatus.

According to some examples, the apparatus comprises: means for storing an identifier of the apparatus, wherein the identifier is used for the reply to the activation signal.

According to some examples, the apparatus comprises an IoT device.

According to some examples, the apparatus comprises an ambient-IoT device.

According to some examples, the delay used by the apparatus comprises at least one of: a processing delay, a wake up delay, a charging delay, a reception delay, or a transmission delay.

According to a second aspect, there is provided an apparatus comprising at least one processor and at least one memory storing instructions that, when executed by the at least one processor, cause the apparatus at least to perform: receiving, by the apparatus, an activation signal; transmitting, by the apparatus, a reply to the activation signal over a carrier; selecting, by the apparatus, the carrier based on a delay used by the device between the receipt of the activation signal and the transmission of the reply.

According to some examples, the carrier is selected based on a mapping between a delay value range or a delay value and the carrier.

According to some examples, the mapping is either a predetermined mapping or is received from a network entity configured to manage a positioning session for the apparatus.

According to some examples, the at least one processor and at least one memory storing instructions cause, when executed by the at least one processor, the apparatus at least to perform: receiving, from the network entity, at least one of: information indicative of an identifier of a network entity configured to activate the apparatus; information indicative of an identifier of a network entity configured to detect the apparatus.

According to some examples, the at least one processor and at least one memory storing instructions cause, when executed by the at least one processor, the apparatus at least to perform: storing an identifier of the apparatus, wherein the identifier is used for the reply to the activation signal.

According to some examples, the apparatus comprises an IoT device.

According to some examples, the apparatus comprises an ambient-IoT device.

According to some examples, the delay used by the apparatus comprises at least one of: a processing delay, a wake up delay, a charging delay, a reception delay, or a transmission delay.

According to a third aspect there is provided a method comprising: receiving, by a device, an activation signal; transmitting, by the device, a reply to the activation signal over a carrier; selecting, by the device, the carrier based on a delay used by the device between the receipt of the activation signal and the transmission of the reply.

According to some examples, the carrier is selected based on a mapping between a delay value range or a delay value and the carrier.

According to some examples, the mapping is either a predetermined mapping or is received from a network entity configured to manage a positioning session for the apparatus.

According to some examples, the method comprises: receiving, from the network entity, at least one of: information indicative of an identifier of a network entity configured to activate the apparatus; information indicative of an identifier of a network entity configured to detect the apparatus.

According to some examples, the method comprises: storing an identifier of the apparatus, wherein the identifier is used for the reply to the activation signal.

According to some examples, the method is performed by an IoT device.

According to some examples, the method is performed by an ambient-IoT device.

According to some examples, the delay used by the apparatus comprises at least one of: a processing delay, a wake up delay, a charging delay, a reception delay, or a transmission delay.

According to a fourth aspect there is provided a computer readable medium comprising instructions which, when executed by an apparatus, cause the apparatus to perform at least the following: receiving, by the apparatus, an activation signal; transmitting, by the apparatus, a reply to the activation signal over a carrier; selecting, by the apparatus, the carrier based on a delay used by the device between the receipt of the activation signal and the transmission of the reply.

According to a fifth aspect, there is provided a non-transitory computer readable medium comprising program instructions that, when executed by an apparatus, cause the apparatus to perform at least the following: receiving, by the apparatus, an activation signal; transmitting, by the apparatus, a reply to the activation signal over a carrier; selecting, by the apparatus, the carrier based on a delay used by the device between the receipt of the activation signal and the transmission of the reply.

According to a sixth aspect there is provided an apparatus comprising: means for sending information indicative of a mapping between a delay value range or a delay value used by the device between the receipt of an activation signal and the transmission of a reply to the activation signal and a carrier used by the device for transmitting the reply.

According to some examples, the information indicative of the mapping is sent to at least one of: the device; or a network entity configured to detect the device.

According to some examples, the apparatus comprises: means for receiving, from the network entity configured to detect the device, an indication of a poor detection quality of the reply; means for determining, in response to receiving the indication, a new mapping between the delay value range or the delay value and a new carrier used by the device for transmitting a new reply; means for sending information indicative of the new mapping to at least one of: the device, or the network entity configured to detect the device.

According to some examples, the apparatus comprises: means for receiving, from the network entity configured to detect the device, positioning information for the device, and the identifier of the network entity configured to detect the device.

According to some examples, the apparatus comprises: means for sending information indicative of a transmit time of the activation signal to at least one of: a network entity configured to activate the device, or the network entity configured to detect the device.

According to a seventh aspect there is provided an apparatus comprising at least one processor and at least one memory storing instructions that, when executed by the at least one processor, cause the apparatus at least to perform: sending, by the apparatus, information indicative of a mapping between a delay value range or a delay value used by a device between the receipt of an activation signal and the transmission of a reply to the activation signal and a carrier used by the device for transmitting the reply.

According to some examples, the information indicative of the mapping is sent to at least one of: the device; or a network entity configured to detect the device.

According to some examples, the at least one processor and at least one memory storing instructions cause, when executed by the at least one processor, the apparatus at least to perform: receiving, from the network entity configured to detect the device, an indication of a poor detection quality of the reply; determining, in response to receiving the indication, a new mapping between the delay value range or the delay value and a new carrier used by the device for transmitting a new reply; sending information indicative of the new mapping to at least one of: the device, or the network entity configured to detect the device.

According to some examples, the at least one processor and at least one memory storing instructions cause, when executed by the at least one processor, the apparatus at least to perform: receiving, from the network entity configured to detect the device, positioning information for the device, and the identifier of the network entity configured to detect the device.

According to some examples, the at least one processor and at least one memory storing instructions cause, when executed by the at least one processor, the apparatus at least to perform: sending information indicative of a transmit time of the activation signal to at least one of: a network entity configured to activate the device, or the network entity configured to detect the device.

According to an eighth aspect there is provided a method comprising: sending, by a network entity, information indicative of a mapping between a delay value range or a delay value used by a device between the receipt of an activation signal and the transmission of a reply to the activation signal and a carrier used by the device for transmitting the reply.

According to some examples, the information indicative of the mapping is sent to at least one of: the device; or a network entity configured to detect the device.

According to some examples, the method comprises receiving, from the network entity configured to detect the device, an indication of a poor detection quality of the reply; determining, in response to receiving the indication, a new mapping between the delay value range or the delay value and a new carrier used by the device for transmitting a new reply; sending information indicative of the new mapping to at least one of: the device, or the network entity configured to detect the device.

According to some examples, the method comprises receiving, from the network entity configured to detect the device, positioning information for the device, and the identifier of the network entity configured to detect the device.

According to some examples, the method comprises sending information indicative of a transmit time of the activation signal to at least one of: a network entity configured to activate the device, or the network entity configured to detect the device.

According to a ninth aspect there is provided a computer readable medium comprising instructions which, when executed by an apparatus, cause the apparatus to perform at least the following: sending, by the apparatus, information indicative of a mapping between a delay value range or a delay value used by a device between the receipt of an activation signal and the transmission of a reply to the activation signal and a carrier used by the device for transmitting the reply.

According to a tenth aspect there is provided a non-transitory computer readable medium comprising program instructions that, when executed by an apparatus, cause the apparatus to perform at least the following: sending, by the apparatus, information indicative of a mapping between a delay value range or a delay value used by a device between the receipt of an activation signal and the transmission of a reply to the activation signal and a carrier used by the device for transmitting the reply.

According to an eleventh aspect there is provided an apparatus comprising: means for receiving a reply from a device, the reply being transmitted by the device in response to an activation signal received by the device; means for receiving information indicative of a mapping between a delay value range or a delay value used by the device between the receipt of the activation signal and the transmission of the reply and a carrier used by the device for transmitting the reply; and means for determining positioning information for the device based on a transmit time of the activation signal, a receipt time of the reply, the carrier over which the reply has been received, and the information indicative of the mapping.

According to some examples, the apparatus comprises: means for receiving at least one of: information indicative of an identifier of a network entity configured to activate the device; information indicative of the transmit time of the activation signal.

According to some examples, the apparatus comprises: means for detecting a poor detection quality of the reply; means for sending information indicative of the poor detection quality to a network entity configured to manage a positioning session for the device.

According to some examples, the apparatus comprises: means for sending the positioning information to a network entity configured to manage a positioning session for the device.

According to a twelfth aspect, there is provided an apparatus comprising at least one processor and at least one memory storing instructions that, when executed by the at least one processor, cause the apparatus at least to perform: receiving a reply from a device, the reply being transmitted by the device in response to an activation signal received by the device; receiving information indicative of a mapping between a delay value range or a delay value used by the device between the receipt of the activation signal and the transmission of the reply and a carrier used by the device for transmitting the reply; and determining positioning information for the device based on a transmit time of the activation signal, a receipt time of the reply, the carrier over which the reply has been received, and the information indicative of the mapping.

According to some examples, the at least one processor and at least one memory storing instructions cause, when executed by the at least one processor, the apparatus at least to perform: receiving at least one of: information indicative of an identifier of a network entity configured to activate the device; information indicative of the transmit time of the activation signal.

According to some examples, the at least one processor and at least one memory storing instructions cause, when executed by the at least one processor, the apparatus at least to perform: detecting a poor detection quality of the reply; sending information indicative of the poor detection quality to a network entity configured to manage a positioning session for the device.

According to some examples, the at least one processor and at least one memory storing instructions cause, when executed by the at least one processor, the apparatus at least to perform: sending the positioning information to a network entity configured to manage a positioning session for the device.

According to a thirteenth aspect, there is provided a method comprising; receiving a reply from a device, the reply being transmitted by the device in response to an activation signal received by the device; receiving information indicative of a mapping between a delay value range or a delay value used by the device between the receipt of the activation signal and the transmission of the reply and a carrier used by the device for transmitting the reply; and determining positioning information for the device based on a transmit time of the activation signal, a receipt time of the reply, the carrier over which the reply has been received, and the information indicative of the mapping.

According to some examples, the method comprises receiving at least one of: information indicative of an identifier of a network entity configured to activate the device; information indicative of the transmit time of the activation signal.

According to some examples, the method comprises: detecting a poor detection quality of the reply; sending information indicative of the poor detection quality to a network entity configured to manage a positioning session for the device.

According to some examples, the method comprises: sending the positioning information to a network entity configured to manage a positioning session for the device.

According to a fourteenth aspect there is provided a computer readable medium comprising instructions which, when executed by an apparatus, cause the apparatus to perform at least the following: receiving a reply from a device, the reply being transmitted by the device in response to an activation signal received by the device; receiving information indicative of a mapping between a delay value range or a delay value used by the device between the receipt of the activation signal and the transmission of the reply and a carrier used by the device for transmitting the reply; and determining positioning information for the device based on a transmit time of the activation signal, a receipt time of the reply, the carrier over which the reply has been received, and the information indicative of the mapping.

According to a fifteenth aspect there is provided a non-transitory computer readable medium comprising program instructions that, when executed by an apparatus, cause the apparatus to perform at least the following: receiving a reply from a device, the reply being transmitted by the device in response to an activation signal received by the device; receiving information indicative of a mapping between a delay value range or a delay value used by the device between the receipt of the activation signal and the transmission of the reply and a carrier used by the device for transmitting the reply; and determining positioning information for the device based on a transmit time of the activation signal, a receipt time of the reply, the carrier over which the reply has been received, and the information indicative of the mapping.

### DESCRIPTION OF FIGURES

Embodiments will now be described, by way of example only, with reference to the accompanying Figures in which:

FIG. 1 shows a first network topology;

FIG. 2 shows a second network topology;

FIG. 3A shows a third network topology for downlink assistance;

FIG. 3B shows the third network topology for uplink assistance;

FIG. 4 shows a fourth network topology;

FIG. 5 shows an example signal flow;

FIG. 6 shows an example method flow;

FIG. 7 shows an example method flow;

FIG. 8 shows an example method flow;

FIG. 9 shows a representation of a control apparatus according to some example embodiments;

FIG. 10 shows a representation of an apparatus according to some example embodiments; and

FIG. 11 shows a schematic representation of a non-volatile memory medium storing instructions which when executed by a processor allow a processor to perform one or more of the steps of the methods disclosed herein.

### DETAILED DESCRIPTION

The present disclosure relates to IoT devices, and in some examples to methods of signalling information that can be used to determine delay at an IoT device between receiving an activation signal and transmitting a response to an activation signal. The delay can be used in some examples to localize the IoT device.

IoT devices usually consume tens or hundreds of milliwatts power during transceiving, while the cost is a few dollars. However, to achieve the internet of everything, IoT devices with ten or even a hundred times lower cost and power consumption are needed, especially for a large number of applications requiring batteryless devices. Regular replacement of batteries in battery powered devices is impractical due to consumption of materials and manpower. Devices that can use energy harvested from a surrounding environment are therefore useful, especially in applications with a large number of device (e.g., ID tags and sensors).

A passive radio is a device that can harness energy from wireless signals sent on specific carriers and/or bandwidths and charges a simple circuitry that, once activated, it will emit/reflect a signal which encodes at least the ID of the passive radio. In some examples described herein, passive radio (tag) transmission is referred to. It should be understood that such passive radio transmission does not necessarily mean active generation and transmission of an RF signal but in some examples could instead include modulating the reflection of an activation signal. This is discussed further below with respect to device types A, B and C. The typical system architecture around a passive radio comprises:
An activator: a device that sends an activation signal targeted at waking up the passive radio.
The passive radio: harnesses energy over a range of frequencies and listens for activation signals. Once such a signal is detected, the passive radio emits/reflects a signal which is specific to a radio ID of the passive radio. In some examples, other passive radios may be included in the system architecture.
A reader: a device that listens and detects the passive radio signals. The reader may or may not be collocated/merged with the activator.

Passive radios may comprise batteryless devices with no energy storage capability at all, and may depend on availability of an external source of energy. Semi-passive devices may have a limited energy storage capability that does not need to be replaced or recharged manually.

3GPP TR 38.848 V0.1.0 describes three ambient IoT device types, A, B and C:
Device A: No energy storage, no independent signal generation/amplification, i.e., backscattering transmission.
Device B: Has energy storage, no independent signal generation, i.e., backscattering transmission. Use of stored energy can include amplification for reflected signals.
Device C: Has energy storage, has independent signal generation, i.e., active RF components for transmission.

The design targets for each device type's power consumption are as follows:
Device A≤10 μW
Device A<Device B<Device C.
Device C≤1 mW

The design targets for complexity for each device are as follows:
Device A: Comparable to UHF RFID
Device A≤Device B≤Device C,
Device C: Orders-of-magnitude lower than NB-IoT

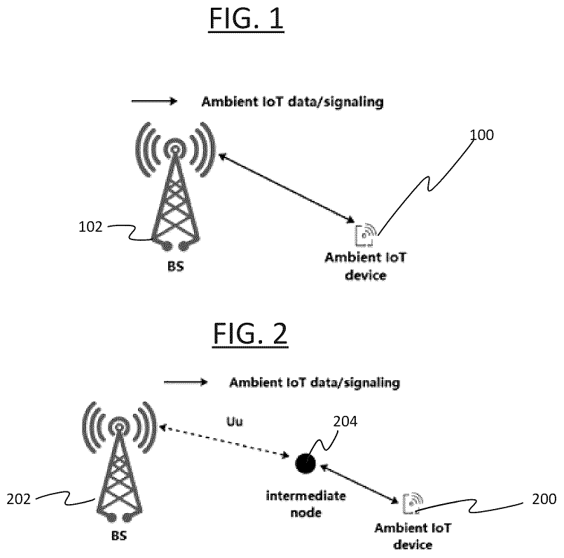

3GPP TR 38.848 describes topologies for Ambient IoT networks and devices. These topologies are shown in FIGS. 1, 2, 3A, 3B and 4. In all of these topologies, the Ambient IoT device may be provided with a carrier wave from other node(s) either inside or outside the topology. The links in each topology may be bidirectional or unidirectional. BS (Base Station), UE (User Equipment), assisting node, or intermediate node could be multiple BSs or UEs, respectively. The mixture of indoor and outdoor placement of such nodes is regarded as a network implementation choice.

FIG. 1 shows a first topology with BS 102 and A-IoT device 100 which communicate directly and bidirectionally. The communication between the base station and the ambient IoT device includes Ambient IoT data and/or signalling. This topology includes the possibility that BS 102 transmitting to A-IoT 100 device is a different from BS 102 receiving from A-IoT device 100.

FIG. 2 shows a second topology with BS 202, an intermediate node 204 and A-IoT device 200. A-IoT device 200 communicates bidirectionally with an intermediate node 204 between device 200 and BS 202. In this topology, intermediate node 204 can be a relay, IAB node, UE, repeater, etc. which is capable of Ambient IoT. Intermediate node 204 transfers the information between BS 202 and the A-IoT device 200.

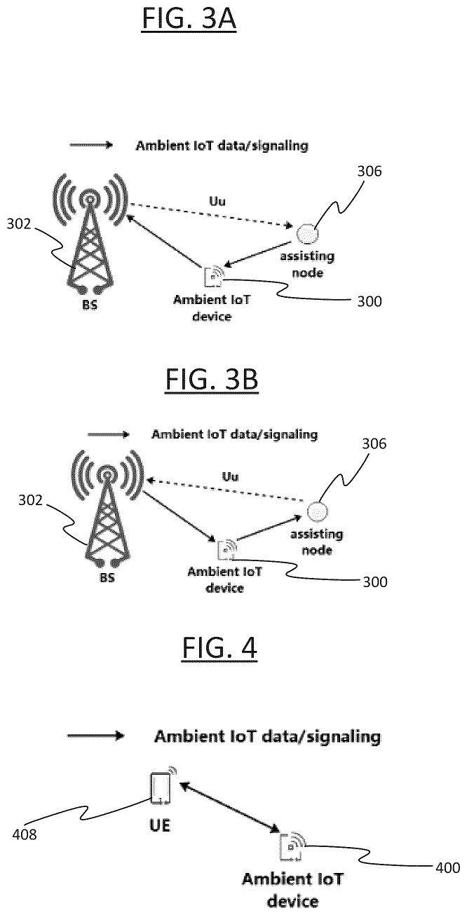

FIGS. 3A and 3B show a third topology. In a downlink assistance option shown in FIG. 3A, A-IoT device 300 transmits data/signaling to a base station 302 and receives data/signaling from an assisting node 306. In an Uplink assistance option shown in FIG. 3B, the A-IoT device receives data/signaling from a base station 302 and transmits data/signaling to the assisting node. In this topology, assisting node 306 can be a relay, IAB (Integrated Access and Backhaul), UE, repeater, etc. which is capable of ambient IoT.

FIG. 4 shows a fourth topology where A-IoT device 400 communicates bidirectionally with UE 408. The communication between UE 408 and A-IoT device 400 includes Ambient IoT data and/or signaling.

To localize a device such as an IoT device (e.g., an A-IoT device), the device can either 1) measure and report positioning signals of multiple sources or 2) transmit positioning signals detectable and measurable by multiple receivers. When synchronization is not possible, Round Trip Time (RTT) measurements can be used, where the device performs 1) and 2) one after the other. For RTT measurements, in addition to signal transmission and measurement, the A-IoT device 3) reports the receive-transmit (RX-TX) time difference. In some examples this can be done over a separate communication channel to the measurements of 1) and 2).

Performing 1), 2) and 3) by an IoT device (e.g., an A-IoT device such as a tag) can be difficult for certain types of devices that may only have enough charge and/or intelligence to perform a subset of tasks 1, 2 and 3. Transmissions from multiple IoT devices of both positioning signals and RX-TX time difference result in high cross-interference between the IoT devices. This is a particular issue for A-IoT devices, where the density of the devices can be many higher orders of magnitude higher than e.g., that of typical New Radio (NR) User Equipment (UE) devices. This can cause orthogonalization in the frequency domain of the A-IoT devices to be difficult.

According to some examples described herein, a method that can be used for localization of a device with reduced interference is provided. This can allow transmissions of multiple A-IoT devices (e.g., tags) to be spread across a set of carriers accordingly with a delay (or delay range) between the A-IoT device and activator observed at the A-IoT device. A device may be provided with a mapping that allows the device to determine the carrier (f) where it should provide its reply based on its observed/expected delay (or delay range) dt. The mapping may comprise a function f(dt). The mapping may comprise a table with delay values or delay value ranges and corresponding carriers that should be used.

The delay used by the device between receiving an activation signal and responding to the activation signal may comprise at least one of the following: a processing delay; a wake up delay; a charging delay; a reception delay; or a transmission delay.

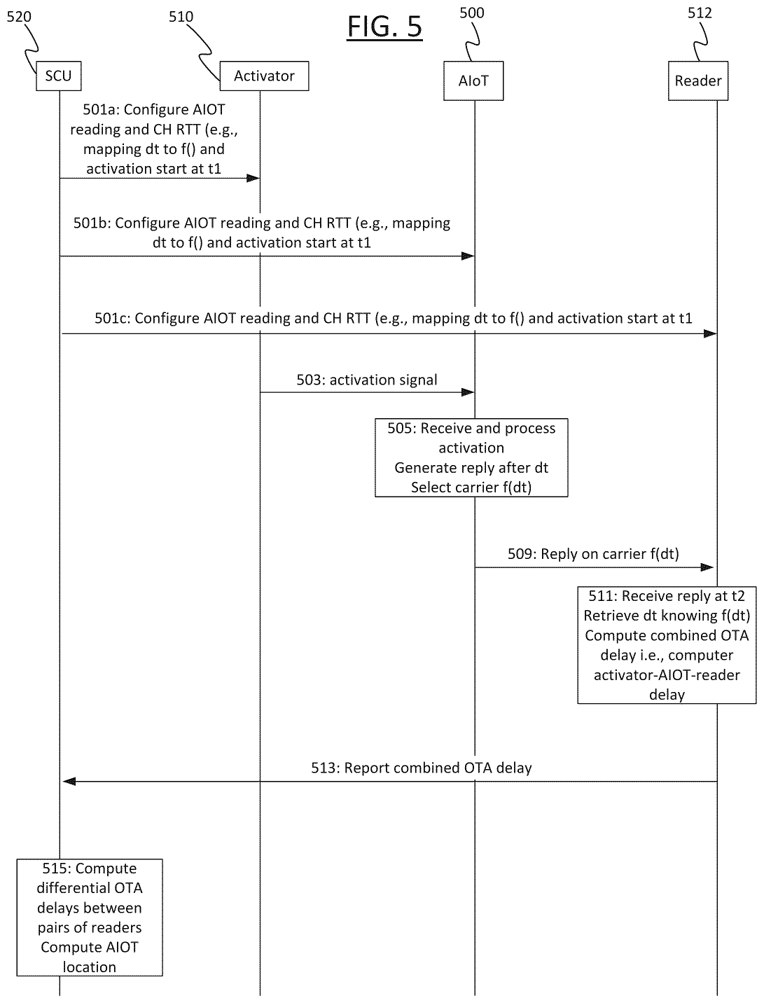

FIG. 5 shows an example method. The method may be denoted as “Carrier-Hopping (CH) RTT” according to some examples. The CH RTT method may be used to determine a delay used by a device between reception of a transmission signal and sending of a reply to the activation signal. In the example of FIG. 5, the delay used by an A-IoT device 500 between reception of an activation signal from activator 510 and transmission of a reply to the activation signal to reader 512 is determined. It will be understood however that CH-RTT could be used to determine the delay between reception and transmission for any device.

At 501a, 501b and 501c a network entity 520 that is configured to manage a localization session for device 500 (e.g., a Session Control Entity (SCU)) configures CH RTT for an apparatus 510 (e.g., an activator) configured to activate device 500, A-IoT device 500 and an apparatus 512 (e.g., a reader) configured to detect device 500. According to some examples, a single apparatus may comprise apparatus 510 and apparatus 512. In some examples, the single apparatus may form part of a RAN node or a UE.

At 501a, 501b and 501c network entity 520 configures a mapping for apparatus 510, device 500 and apparatus 512 respectively. This may be performed by sending the mapping to each of apparatus 510, device 500 and apparatus 512. The mapping may be used by device 520 for selecting a carrier (e.g., a frequency carrier) for transmitting a reply to an activation signal. In some examples the mapping may comprise a function of the observed/expected delay f(dt), or a table of carriers to use for different delay values or delay value ranges.

According to some examples, during the method of FIG. 5 apparatuses 520, 510 and 512 are synchronized and do not adjust their clocks.

According to some examples, if apparatus 512 determines that specific carriers are receiving too many AIOT device replies, then apparatus 512 can inform the apparatus 520 to configure a different mapping function where specific dt ranges or values are assigned to other carriers.

At 503, apparatus 510 sends an activation signal to device 500. The activation signal is sent at a transmission time t1. Time t1 may be configured by apparatus 512 and may be known by all readers such as apparatus 512. Information indicative of time t1 may be signalled to apparatus 510 by apparatus 520, at 501a for example. Information indicative of time t1 may be sent to apparatus 512 by apparatus 520, at 501c for example.

At 505, device 500 receives the activation signal from apparatus 510 at time t1+OTA_delay_A, where OTA_delay_A is the over-the-air propagation delay between apparatus 510 and device 500.

At 507, device 500 delays sending a reply to the activation signal received at 503 for a time dt. Time dt may comprise at least one of the following: a processing delay; a wake up delay; a charging delay; a reception delay; or a transmission delay. Device 500 is then ready to reply at time t1+OTA_delay_A+dt. Device 500 can then generate a reply on a carrier according to the mapping received at 501b by evaluating/measuring dt and selecting a carrier according to the mapping.

At 509, device 500 sends, to apparatus 512, a reply to the activation signal over the carrier selected according to the mapping of dt. At 511, apparatus 512 receives the reply at time t2=t1+OTA_delay_A+dt+OTA_delay_R, where OTA_delay_R is the over-the-air propagation delay between apparatus 500 and device 512. It should be noted that device 500 may reply on different carriers, in different reading sessions, if an associated processing/wake up/charging/reception/transmission delay dt varies (e.g., this may happen when e.g., device 500 holds an initial charge, and thus tends to react faster upon hearing the activation signal).

At 511, based on the carrier that the reply has been received on at 509, apparatus 512 can determine a delay value (or delay value range) dt. Knowing dt, having measured t2 and using a value of t1, apparatus 512 can determine the combined over-the-air (OTA) propagation delay OTA_delay_A+OTA_delay_R. This can be used as positioning information for device 500.

At 513 the combined OTA propagation delay can be reported to apparatus 520.

At 515, apparatus 520 can use the positioning information received at 513 to determine a location of device 500. When apparatus 510 and apparatus 512 are not collocated, apparatus 520 can compute differences between different reader measurements (including the measurement of apparatus 512) to remove the unknown, but common OTA_delay_A. The differential measurements from a reader R1 and a reader R2 are therefore equal to OTA_delay_R1-OTA_delay_R2. Apparatus 520 can apply a multilateration method of choice (e.g., least squares) to compute device 500 location.

When apparatus 510 and apparatus 512 are collocated, apparatus can compute OTA-delay_R from a single reader, as OTA_delay_A=OTA_delay_R (or at least approximately equals).

According to examples of FIG. 5, positioning of device 500 (which may be an AloT device for example) can be performed without needing to synchronize device 500 with the network comprising apparatuses 520, 510 and 512. Cross interference between multiple devices may also be reduced as multiple devices can be multiplexed in frequency. Further, device 500 does not need to report RX-TX time different dt explicitly, which reduces reporting overhead. This can reduce latency and charge requirements of A-IoT devices, for example.

The configuration information sent at 501a, 501b and 501c may comprise a Radio Resource Configuration (RRC) Information Element (IE) or a Medium Access Control (MAC) IE, for example. The configuration information sent at 501a, 501b and 501c may include a single message or two or more messages.

The configuration information sent at 501a may comprise at least one of: information indicative of the mapping of dt values or value ranges to carriers; a transmit time of the activation signal (which may be configured by apparatus 520); an identifier of device 500.

The configuration information sent at 501b may comprise at least one of: information indicative of the mapping of dt values or value ranges to carriers; a transmit time of the activation signal (which may be configured by apparatus 520); identifier of apparatus 510; identifier of apparatus 512. According to some examples, the mapping between delay value or delay value range dt and a carrier may be via a function f( ) which could be closed form, or given as a table. For example, the function f( ) may be defined as:

$$f ( d t ) = \{ \begin{matrix}{c}_{1} , & dt ∈ {[ d {t}_{A} , {dt}_{B} ]}_{1} \\ & … , … \\ {c}_{N} , & dt ∈ {[ d {t}_{A} , {dt}_{B} ]}_{N}\end{matrix}$$

where cᵢ denotes the i-th carrier frequency, and [dt_{A}, dt_{B}]ᵢ is the i-th delay interval.

If device 500 comprises a type C A-IoT device, in some examples the mapping (e.g., the function f(dt)) may be configured at apparatus 520 and then sent to device 500. If device 500 comprises a type A or type B A-IoT device, in some examples the mapping (e.g., the function f(dt)) may be a fixed device implementation and known by apparatus 520; in such examples, the mapping may only be sent to apparatus 510 and 512, rather than to device 500.

The configuration information sent at 501c may comprise at least one of: information indicative of the mapping of dt values or value ranges to carriers; a transmit time of the activation signal (which may be configured by apparatus 520); an identifier of device 500.

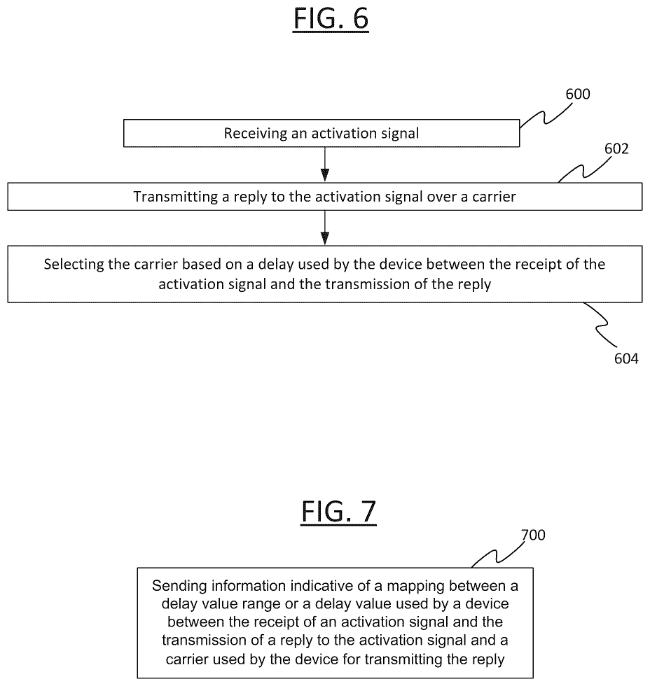

FIG. 6 shows an example method flow. The method may be performed, for example, by an apparatus such as device 500. The apparatus may comprise an IoT device or A-IoT device.

At 600, the method comprises receiving an activation signal.

At 602, the method comprises transmitting a reply to the activation signal over a carrier.

At 604, the method comprises selecting the carrier based on a delay used by the apparatus between the receipt of the activation signal and the transmission of the reply.

FIG. 7 shows an example method flow. The method may be performed, for example, by an apparatus configured to manage a positioning system for a device, such as apparatus 520. The apparatus may comprise an SCU.

At 700, the method comprises sending information indicative of a mapping between a delay value range or a delay value used by a device between the receipt of an activation signal and the transmission of a reply to the activation signal and a carrier used by the device for transmitting the reply. According to some examples, the information may be sent to at least one of: an apparatus configured to activate a device (e.g., activator 510); a device (e.g., A-IoT device 500); an apparatus configured to detect a device (e.g., reader 512).

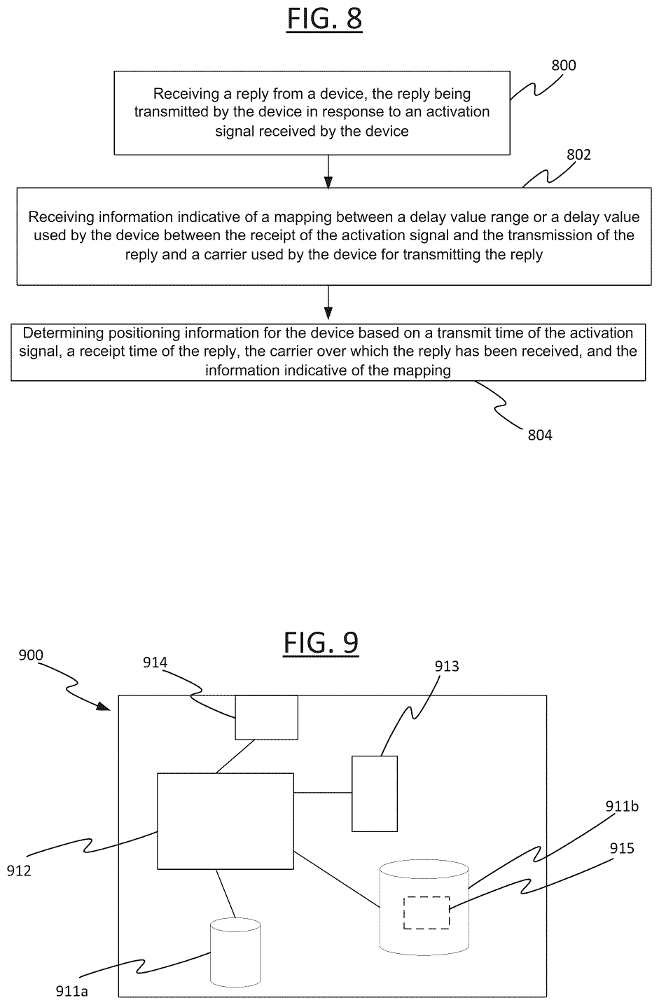

FIG. 8 shows an example method flow. The method may be performed, for example, by an apparatus configured to detect a device (e.g., reader 512).

At 800, the method comprises receiving a reply from a device, the reply being transmitted by the device in response to an activation signal received by the device.

At 802, the method comprises receiving information indicative of a mapping between a delay value range or a delay value used by the device between the receipt of the activation signal and the transmission of the reply and a carrier used by the device for transmitting the reply.

At 804, the method comprises determining positioning information for the device based on a transmit time of the activation signal, a receipt time of the reply, the carrier over which the reply has been received, and the information indicative of the mapping.

FIG. 9 illustrates an example of a control apparatus 900 for controlling a network (e.g., an apparatus for configured to manage a positioning session for an A-IoT device such as SCU 520). The control apparatus may comprise at least one random access memory (RAM) 911a, at least on read only memory (ROM) 911b, at least one processor 912, 913 and an input/output interface 914. The at least one processor 912, 913 may be coupled to the RAM 911a and the ROM 911b. The at least one processor 912, 913 may be configured to execute an appropriate software code 915. The software code 915 may, for example, allow the at least one processor 912, 913 to perform one or more steps of any method flow described herein. The software code 915 may be stored in the ROM 911b. The control apparatus 900 may be interconnected with another control apparatus 900 controlling another function of the RAN or the core network.

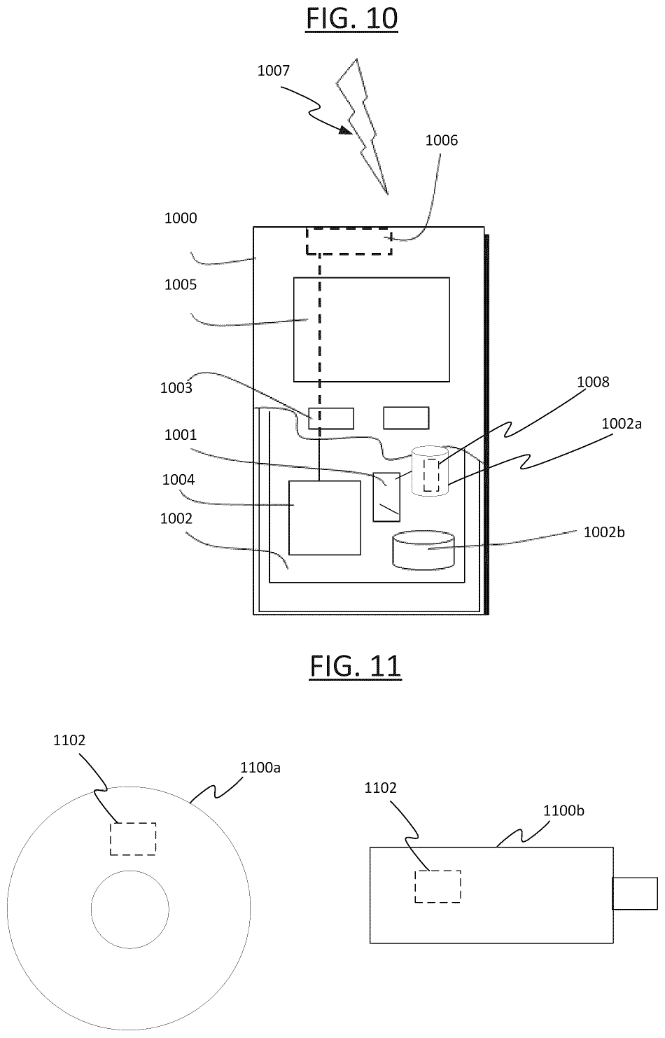

FIG. 10 illustrates an example of a terminal 1000, such as a UE. In some examples, a terminal may be used as an activator and/or a receiver. The terminal 1000 may be provided by any device capable of sending and receiving radio signals. In some examples, the terminal may comprise a user equipment, a mobile station (MS) or mobile device, such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 1000 may provide, for example, communication of data for carrying communications. The communications may be one or more of voice, electronic mail (email), text message, multimedia, data, machine data and so on.

The terminal 1000 may be configured to receive signals over an air or radio interface 1007 via appropriate apparatus for receiving and may transmit signals via appropriate apparatus for transmitting radio signals. In FIG. 10, transceiver apparatus is designated schematically by block 1006. The transceiver apparatus 1006 may be provided, for example, by means of a radio part and associated antenna arrangement. The antenna arrangement may be arranged internally or externally to the mobile device.

The terminal 1000 may be provided with at least one processor 1001, at least one memory ROM 1002a, at least one RAM 1002b and other possible components 1003 and 1004 for use in software and hardware aided execution of tasks it is designed to perform, including control of access to and communications with access systems and other communication devices. The at least one processor 1001 is coupled to the RAM 1002b and the ROM 1002a. The at least one processor 1001 may be configured to execute an appropriate software code 1008. The software code 1008 may for example allow to perform one or more of steps of any method flow described herein. The software code 1008 may be stored in the ROM 1002a.

The processor, storage and other relevant control apparatus can be provided on an appropriate circuit board and/or in chipsets. This example is denoted by reference 1002. The device may optionally have a user interface, such as key pad 1005, touch sensitive screen or pad, combinations thereof or the like. Optionally, one or more of a display, a speaker and a microphone may be provided depending on the type of the device.

FIG. 11 shows a schematic representation of non-volatile memory media 1100a (e.g. computer disc (CD) or digital versatile disc (DVD)) and 1100b (e.g. universal serial bus (USB) memory stick) storing instructions and/or parameters 1102 which when executed by a processor allow the processor to perform one or more of the steps of any method flow described herein.

It should be understood that the apparatuses may comprise or be coupled to other units or modules etc., such as radio parts or radio heads, used in or for transmission and/or reception. Although the apparatuses have been described, in some examples as one entity, different modules and memory may be implemented in one or more physical or logical entities.

It is noted that whilst some examples have been described in relation to 5G networks, similar techniques and/or mechanisms can be applied in relation to other networks and communication systems (e.g., 6G and beyond). Therefore, although certain examples were described above, by way of illustration with reference to certain example architectures for wireless networks, technologies and standards, other examples may be applied to any other suitable forms of communication systems than those illustrated and described herein.

It is also noted herein that while the above details various examples, there are several variations and modifications which may be made to any of the aforementioned example solutions without departing from the scope of the examples described herein.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various examples may be implemented in hardware or special purpose circuitry, software, logic or any combination thereof. Some examples detailed in the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used herein, the term “circuitry” may refer to one or more or all of the following examples:
(a) hardware-only circuit implementations (such as, implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “means” as used in the description and in the claims may refer to one or more individual elements configured to perform the corresponding recited functionality or functionalities, or it may refer to several elements that perform such functionality or functionalities. Furthermore, several functionalities recited in the claims may be performed by the same individual means or the same combination of means. For example performing such functionality or functionalities may be caused in an apparatus by a processor that executes instructions stored in a memory of the apparatus.

The various examples detailed in the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out one or more steps of any method flow described herein. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as DVD and the data variants thereof, CD. The physical media may be implemented as a non-transitory media.

The term “non-transitory,” as used herein, is a limitation of the medium itself (e.g., tangible, not a signal) as opposed to a limitation on data storage persistency (e.g., RAM vs. ROM).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASIC), FPGA, gate level circuits and processors based on multi core processor architecture, as non-limiting examples.

Examples of the subject disclosure may be practiced in various components, such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for the various examples described herein is set out by the independent claims. The examples, if any, described herein that do not fall under the scope of the independent claims are to be interpreted as examples useful for understanding various facets of the subject disclosure.

The foregoing description has provided by way of non-limiting examples to provide a full and informative description the subject disclosure. However, various modifications and adaptations may become apparent to those skilled in the relevant arts in view of the foregoing description, when read in conjunction with the accompanying drawings and the claims. However, all such and similar modifications of the teachings of this disclosure will still fall within the scope of the examples described herein. Indeed, there is a further example comprising a combination of one or more examples with any of the other examples previously described herein.

1-21. (canceled)

22. An apparatus comprising:
means for receiving an activation signal;
means for transmitting a reply to the activation signal over a carrier;
means for selecting the carrier based on a delay used by the apparatus between the receipt of the activation signal and the transmission of the reply.

23. The apparatus according to claim 22, wherein the carrier is selected based on a mapping between a delay value range or a delay value and the carrier.

24. The apparatus according to claim 22, wherein the mapping is either a predetermined mapping or is received from a network entity configured to manage a positioning session for the apparatus.

25. The apparatus according to claim 22, the apparatus further comprising:
means for receiving, from the network entity, at least one of:
information indicative of an identifier of a network entity configured to activate the apparatus;
information indicative of an identifier of a network entity configured to detect the apparatus.

26. The apparatus according to claim 22, the apparatus further comprising:
means for storing an identifier of the apparatus, wherein the identifier is used for the reply to the activation signal.

27. The apparatus according to claim 22, wherein the delay used by the apparatus comprises at least one of: a processing delay, a wake up delay, a charging delay, a reception delay, or a transmission delay.

28. An apparatus configured to manage a positioning session for a device, the apparatus comprising:
means for sending information indicative of a mapping between a delay value range or a delay value used by the device between the receipt of an activation signal and the transmission of a reply to the activation signal and a carrier used by the device for transmitting the reply.

29. The apparatus according to claim 28, wherein the information indicative of the mapping is sent to at least one of: the device; or a network entity configured to detect the device.

30. The apparatus according to claim 29, the apparatus further comprising:
means for receiving, from the network entity configured to detect the device, an indication of a poor detection quality of the reply;
means for determining, in response to receiving the indication, a new mapping between the delay value range or the delay value and a new carrier used by the device for transmitting a new reply;
means for sending information indicative of the new mapping to at least one of: the device, or the network entity configured to detect the device.

31. The apparatus according to claim 29, the apparatus further comprising:
means for receiving, from the network entity configured to detect the device, positioning information for the device, and the identifier of the network entity configured to detect the device.

32. The apparatus according to claim 29, the apparatus further comprising:
means for sending information indicative of a transmit time of the activation signal to at least one of: a network entity configured to activate the device, or the network entity configured to detect the device.

33. An apparatus comprising:
means for receiving a reply from a device, the reply being transmitted by the device in response to an activation signal received by the device;
means for receiving information indicative of a mapping between a delay value range or a delay value used by the device between the receipt of the activation signal and the transmission of the reply and a carrier used by the device for transmitting the reply; and
means for determining positioning information for the device based on a transmit time of the activation signal, a receipt time of the reply, the carrier over which the reply has been received, and the information indicative of the mapping.

34. An apparatus according to claim 33, the apparatus further comprising means for receiving at least one of:
information indicative of an identifier of a network entity configured to activate the device;
information indicative of the transmit time of the activation signal.

35. The apparatus according to claim 33, the apparatus further comprising:
means for detecting a poor detection quality of the reply;
means for sending information indicative of the poor detection quality to a network entity configured to manage a positioning session for the device.

36. The apparatus according to claim 33, the apparatus further comprising:
means for sending the positioning information to a network entity configured to manage a positioning session for the device.
